(19) United States
(12) Patent Application Publication
(10) Pub. No.: US 2022/0358348 A1
(43) Pub. Date: Nov. 10, 2022

(54) PROCESSING IMAGES CAPTURED BY DRONES USING BRAIN EMULATION NEURAL NETWORKS

(71) Applicant: X Development LLC, Mountain View, CA (US)

(72) Inventors: Sarah Ann Laszlo, Mountain View, CA (US); Jeffrey Bush, Los Altos, CA (US); Doris Tang, San Francisco, CA (US)

(21) Appl. No.: 17/307,667

(22) Filed: May 4, 2021

(51) Int. Cl. G06N 3/063; G06N 3/08; G06K 9/00

(52) U.S. Cl. CPC G06N 3/063; G06N 3/08; G06K 9/00651; G06K 9/00657

(57) ABSTRACT

Methods, systems, and apparatus, including computer programs encoded on a computer storage medium, for receiving a representation of an image captured by an onboard camera of a drone and providing the representation of the image to a drone image processing neural network having a brain emulation sub-network with an architecture that is specified by synaptic connectivity between neurons in a brain of a biological organism, including instantiating a respective artificial neuron corresponding to each biological neuron of multiple biological neurons, and instantiating a respective connection between each pair of artificial neurons that correspond to a pair of biological neurons that are connected by a synaptic connection, and processing the representation of the image using the drone image processing neural network having the brain emulation sub-network to generate a network output that defines a prediction characterizing the image captured by the onboard camera of the drone.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes an image processing system implemented as computer programs on one or more computers in one or more locations that processes images captured by drones using a neural network, referred to herein as a “drone image processing” neural network (can also be referred to as a “reservoir computing” neural network) to perform prediction tasks. The drone image processing neural network includes a sub-network, referred to herein as a “brain emulation” sub-network, which is derived from a synaptic connectivity graph representing synaptic connectivity in the brain of a biological organism. The drone image processing neural network may be configured to process images captured by drones to perform any of a variety of prediction tasks, e.g., segmentation tasks, classification tasks, or regression tasks.

The techniques described herein can be used to process visual information for control of a drone, e.g., using images captured by a drone to inform safe landing locations for the drone.

Throughout this specification, a “neural network” refers to an artificial neural network, i.e., that is implemented by one or more computers. For convenience, a neural network having an architecture derived from a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

As used within this specification, a drone, also known as an unmanned aerial vehicle (UAV), uncrewed aerial vehicle, unmanned aircraft, or uncrewed aircraft (UA), is generally an aircraft without a human pilot onboard. A drone can be fully autonomous or partially autonomous, e.g., where operations of the drone can be controlled by a remote pilot.

According to a first aspect there is provided a method performed by one or more data processing apparatus including receiving a representation of an image captured by an onboard camera of a drone, providing the representation of the image to a drone image processing neural network having a brain emulation sub-network with an architecture that is specified by synaptic connectivity between neurons in a brain of a biological organism, where specifying the brain emulation sub-network architecture includes instantiating a respective artificial neuron in the brain emulation sub-network corresponding to each biological neuron of multiple biological neurons in the brain of the biological organism, and instantiating a respective connection between each pair of artificial neurons in the brain emulation sub-network that correspond to a pair of biological neurons in the brain of the biological organism that are connected by a synaptic connection, and processing the representation of the image using the drone image processing neural network having the brain emulation sub-network to generate a network output that defines a prediction characterizing the image captured by the onboard camera of the drone.

These and other embodiments can each optionally include one or more of the following features. In some implementations, the prediction characterizing the image includes a segmentation of the image into multiple possible categories. The segmentation of the image into the multiple possible categories can include, for each pixel of the image, a respective score for each of the multiple possible categories, where the score for a possible category defines a likelihood that the pixel is included in the possible category. The multiple possible categories can include one or more of i) a power line category, ii) a road category, or iii) a vegetation category, where a pixel is included in the power line category if the pixel is included in a power line depicted in the image, where the pixel is included in the road category if the pixel is included in a road depicted in the image, and where the pixel is included in the vegetation category if the pixel is included in vegetation depicted in the image.

As used throughout this document, “vegetation” can include any appropriate plant life, (e.g., trees, shrubs, hedges, etc.), in particular, plant life that could obstruct the ability of a drone to navigate or land.

In some implementations, the prediction characterizing the image includes a classification of the image into multiple possible classes. The classification of the image into the multiple possible classes can include a respective score for each possible class, where the score for a possible class defines a likelihood that the image is included in the possible class. The multiple possible classes can include: (i) a first class indicating that less than a threshold area of the image is occupied by a category of entity, and (ii) a second class indicating that at least the threshold area of the image is occupied by the category of entity, for example, a hazard that is i) a power line, ii) vegetation, or iii) a road.

In some implementations, the drone image processing neural network further includes an input sub-network, where the input sub-network is configured to process the image to generate an embedding of the image, and where the brain emulation sub-network is configured to process the embedding of the image that is generated by the input sub-network.

In some implementations, the methods further include applying one or more predefined image processing operations to the image prior to providing the representation of the image to the drone image processing neural network. Image processing can include an edge enhancement operation including applying a Laplacian of Gaussian filter to the image. Image processing can include identification of one or more lines depicted in the image and a respective orientation of each of the one or more lines.

In some implementations, image processing further includes reorienting the image to align at least one line captured within the image along a predefined axis.

In some implementations, the drone image processing neural network further includes an output sub-network, wherein the output sub-network is configured to process the network output generated by the brain emulation sub-network to generate the prediction characterizing the image.

In some implementations, processing the representation of the image using the drone image processing neural network having the brain emulation sub-network is performed by an onboard computer system of the drone.

In some implementations, the methods include providing the prediction characterizing the image to a navigation system of the drone, where the navigation system of the drone generates control signals for operation of the drone.

In some implementations, specifying the brain emulation sub-network architecture further includes, for each pair of artificial neurons in the brain emulation sub-network that are connected by a respective connection, instantiating a weight value for the connection based on a proximity of a pair of biological neurons in the brain of the biological organism that correspond to the pair of artificial neurons in the brain emulation sub-network. Weight values associated with respective particular synaptic connections between pairs of neurons in the brain can be based on the proximity of the pair of neurons in the brain of the biological organism. Values of the brain emulation sub-network parameters can be static during training of the brain-emulation sub-network.

According to another aspect there are provided one or more non-transitory computer storage media storing instructions that when executed by one or more computers cause the one or more computers to perform the operations of the systems described herein.

According to another aspect there is provided a system comprising one or more computers and one or more storage devices storing instructions that when executed by the one or more computers cause the one or more computers to implement methods performed by one or more data processing apparatus for performing the operations of the systems described herein.

Particular embodiments of the subject matter described in this specification can be implemented so as to realize one or more of the following advantages.

An advantage of the image processing system described in this specification is that the processing of a plurality of images (e.g., real-time imaging data captured by an onboard camera of a drone) can be performed by the reservoir computing neural network (“drone image processing neural network”) at a rate that is equal to or faster than a capture time for acquiring the images (e.g., faster than 1 Hz). Utilizing a drone image processing neural network that includes a brain emulation sub-network that is selected for its effectiveness at performing particular tasks, e.g., detecting lines/edges, can reduce an amount of time utilized by the drone image processing neural network to generate a prediction.

Additionally, by performing the processing of the images using the brain emulation neural network, significant (e.g., two-fold or more) reduction in power consumption can be achieved. A reduction in power consumption can reduce weight requirements associated with onboard power supplies, e.g., batteries and/or renewable power sources, such that an overall weight of the drone can be reduced. The processing of imagery captured by an onboard camera can be utilized to adjust in real-time to unexpected hazards (e.g., safe vs unsafe landing zones) and provide real-time control signals to the drone.

The drone image processing neural network can achieve the advantages of lower latency in generating predictions and lower power consumption because it includes a brain emulation sub-network. The brain emulation sub-network leverages an architecture and weight values derived from a biological brain to enable the drone image processing neural network to achieve an acceptable performance while occupying less space in memory and performing fewer arithmetic operations than would be required by other neural networks, e.g., with hand-engineered or learned architectures.

The image processing system described in this specification can process an image captured by a drone using a drone image processing neural network to generate a prediction characterizing the image, e.g., a pixel-wise segmentation of the image that identifies which pixels of the image are included in features of interest, e.g., power lines, vegetation, roads, etc. The characterized features of interest can be utilized by the drone to identify hazards, e.g., to identify safe vs. unsafe locations to land. The drone image processing neural network can be a reservoir computer neural network and includes a brain emulation sub-network that is derived from a synaptic connectivity graph representing synaptic connectivity in the brain of a biological organism. The brain of the biological organism may be adapted by evolutionary pressures to be effective at solving certain tasks. For example, in contrast to many conventional computer vision techniques, a biological brain may process visual (image) data to generate a robust representation of the visual data that may be insensitive to factors such as the orientation and size of elements (e.g., objects) characterized by the visual data. The brain emulation sub-network may inherit the capacity of the biological brain to effectively solve tasks (in particular, image processing tasks), and thereby enable the image processing system to perform image processing tasks more effectively, e.g., with higher accuracy.

The image processing system may generate pixel-level segmentations of images, i.e., that can identify each pixel of the image as being included in a respective category. In contrast, a person may manually label the positions of entities (e.g., power lines) in an image, e.g., by drawing a bounding box around the entity. The more precise, pixel-level segmentations generated by the image processing system may facilitate more effective downstream processing of the image segmentations, for example, to control one or more operations of a drone in real-time (e.g., hazard avoidance when navigating and/or landing the drone).

The brain emulation sub-network of the drone image processing neural network may have a very large number of parameters and a highly recurrent architecture, i.e., as a result of being derived from a synaptic connectivity graph representing synaptic connectivity in the brain of a biological organism. Therefore, training the brain emulation sub-network using machine learning techniques may be computationally-intensive and prone to failure. Rather than training the brain emulation sub-network, the image processing system may determine the parameter values of the brain emulation sub-network based on the predicted strength of connections between corresponding neurons in the biological brain. The strength of the connection between a pair of neurons in the biological brain may characterize, e.g., the amount of information flow through a synapse connecting the neurons. In this manner, the image processing system may harness the capacity of the brain emulation sub-network, e.g., to generate representations that are effective for processing images, without requiring the brain emulation sub-network to be trained. By refraining from training the brain emulation sub-network, the image processing system may reduce consumption of computational resources, e.g., memory and computing power, during training of the drone image processing neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example data flow for generating a synaptic connectivity graph representing synaptic connectivity between neurons in the brain of a biological organism.

FIG. 1B shows an example operating environment for a drone including a drone image processing neural network.

FIG. 2 shows an example image processing system.

FIG. 3 shows an example of an image and an example of a hazard segmentation of the image.

FIG. 4 shows an example architecture selection system for generating a brain emulation neural network.

FIG. 5 is a flow diagram of an example process for processing an image using a drone image processing neural network to generate a prediction characterizing the image.

FIG. 6 is a block diagram of an example computer system.

Like reference numbers and designations in the various drawings indicate like elements.

### DETAILED DESCRIPTION

Imagery captured by a camera mounted on a drone can be processed by a drone image processing neural network that includes a brain emulation sub-network to generate a prediction characterizing the captured image, e.g., perform a pixel-wide segmentation of the image that identifies which pixels of the image include structural features (e.g., power lines, roads, trees, etc.) to determine safe locations on the ground to land the drone.

A pre-processing step including, for example, a Laplacian of Gaussian filter and a Hough transform, can be applied to the image to highlight features within the image, in particular, to highlight edges/lines associated with power lines, roads, and other features having a canonical shape. The processed image can be provided to an input sub-network to generate an embedded tensor of the processed image. (As used throughout this specification, a tensor can refer to an ordered collection of numerical values, e.g., a vector or matrix of numerical values). The embedded vector is provided to the drone image processing neural network that includes a brain emulation sub-network and that is suitable for detecting/categorizing the particular canonical shapes of interest, e.g., power lines, roads, vegetation (e.g., trees), etc. The output of the drone image processing neural network that includes a brain emulation sub-network can define a pixel-wise segmentation of the image into a set of possible categories. More specifically, the output can include, for each pixel in the image, a respective score for each category in the set of possible categories that defines a likelihood that the pixel belongs to the category. Examples of categories can include, for example, power lines, roads, vegetation, etc.

An additional drone navigation system can receive the pixel-wise segmentation generated by the drone image processing neural network that includes a brain emulation sub-network and generate control signals for the drone navigation, e.g., identify a safe landing zone for the drone and provide navigation instructions accordingly.

In some embodiments, multiple drone image processing neural networks that include respective brain emulation sub-networks can be utilized, where each of the drone image processing neural network that includes a brain emulation sub-network is selected to process a different category of image. For example, the different categories can include different angular orientations of power lines, e.g., 0-45 degrees, 45-90 degrees, etc. In another example, the different categories can include different elevations at which the image is captured by the onboard camera on the drone, e.g., 0-50 foot elevation, 50-100 foot elevation, etc. Alternatively, an angular orientation of the power lines within the processed image can be determined, e.g., by a secondary neural network, and the image can be rotated such that the features (e.g., power lines) are oriented at an angle that is optimized for the selected drone image processing neural network that includes a brain emulation sub-network.

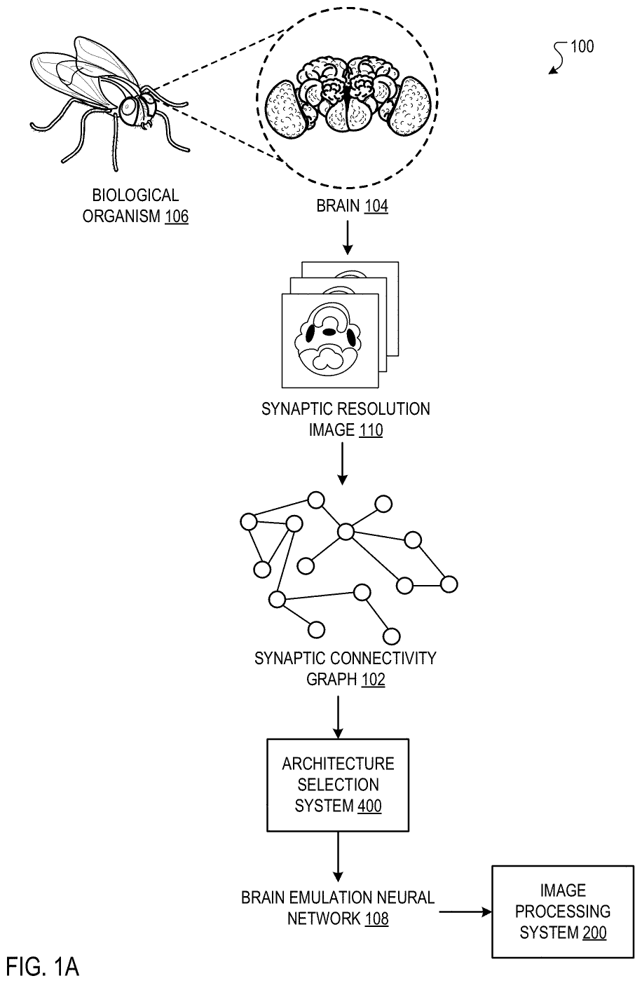

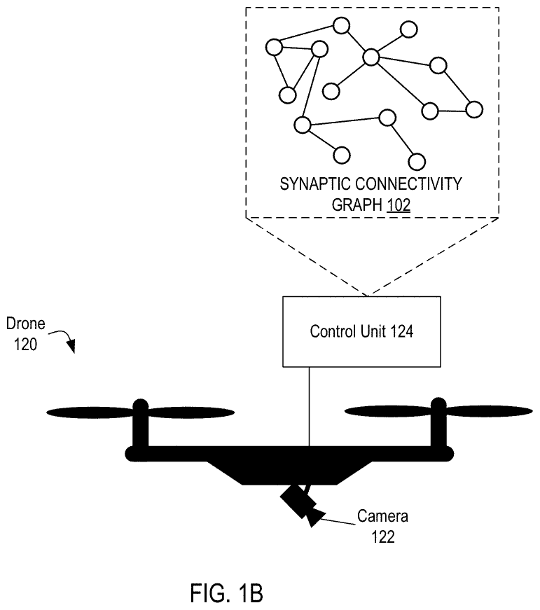

FIG. 1A shows an example data flow 100 for generating a synaptic connectivity graph 102 representing synaptic connectivity between neurons in the brain 104 of a biological organism 106. As used throughout this document, a brain may refer to any amount of nervous tissue from a nervous system of a biological organism, and nervous tissue may refer to any tissue that includes neurons (i.e., nerve cells). The biological organism 106 may be, e.g., a worm, a fly, a mouse, a cat, or a human.

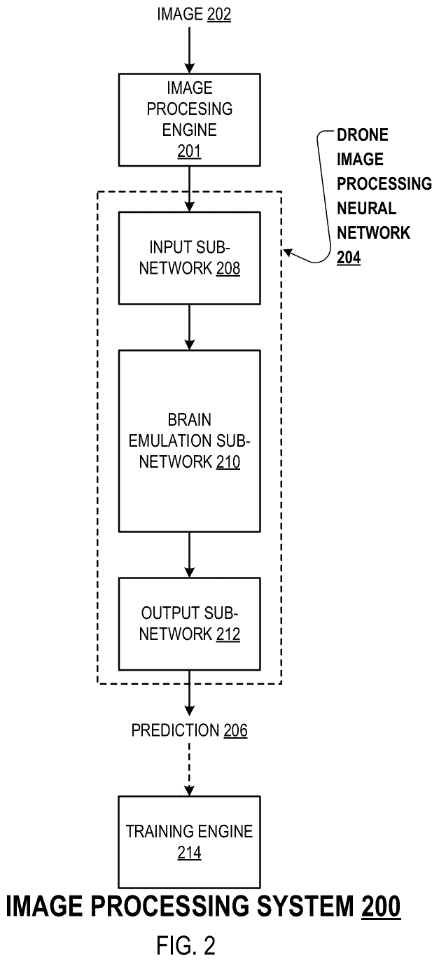

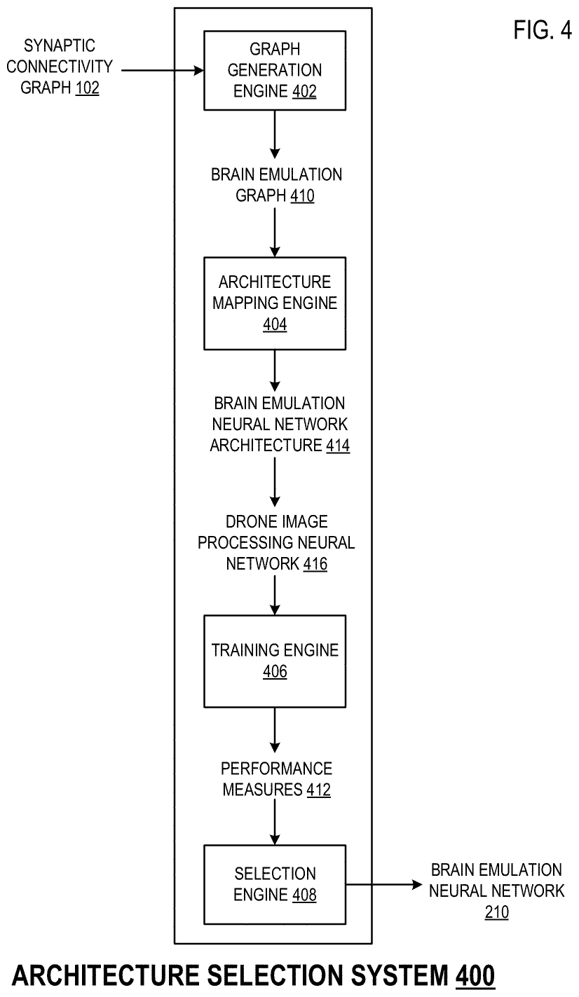

An architecture selection system 400 processes the synaptic connectivity graph 102 to generate a brain emulation neural network 108, and an image processing system 200 uses the brain emulation neural network for processing images. An example image processing system 200 is described in more detail with reference to FIG. 2, and an example architecture selection system 400 is described in more detail with reference to FIG. 4.

An imaging system may be used to generate a synaptic resolution image 110 of the brain 104. An image of the brain 104 may be referred to as having synaptic resolution if it has a spatial resolution that is sufficiently high to enable the identification of at least some synapses in the brain 104. Put another way, an image of the brain 104 may be referred to as having synaptic resolution if it depicts the brain 104 at a magnification level that is sufficiently high to enable the identification of at least some synapses in the brain 104. The image 110 may be a volumetric image, i.e., that characterizes a three-dimensional representation of the brain 104. The image 110 may be represented in any appropriate format, e.g., as a three-dimensional array of numerical values.

The imaging system may be any appropriate system capable of generating synaptic resolution images, e.g., an electron microscopy system. The imaging system may process “thin sections” from the brain 104 (i.e., thin slices of the brain attached to slides) to generate output images that each have a field of view corresponding to a proper subset of a thin section. The imaging system may generate a complete image of each thin section by stitching together the images corresponding to different fields of view of the thin section using any appropriate image stitching technique. The imaging system may generate the volumetric image 110 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system may be used to process the synaptic resolution image 110 to generate the synaptic connectivity graph 102. The synaptic connectivity graph 102 specifies a set of nodes and a set of edges, such that each edge connects two nodes. To generate the graph 102, the graphing system identifies each neuron in the image 110 as a respective node in the graph, and identifies each synaptic connection between a pair of neurons in the image 110 as an edge between the corresponding pair of nodes in the graph.

The graphing system may identify the neurons and the synapses depicted in the image 110 using any of a variety of techniques. For example, the graphing system may process the image 110 to identify the positions of the neurons depicted in the image 110, and determine whether a synapse connects two neurons based on the proximity of the neurons (as will be described in more detail below). In this example, the graphing system may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system may identify contiguous clusters of voxels in the neuron probability map as being neurons.

Optionally, prior to identifying the neurons from the neuron probability map, the graphing system may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 110 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system may identify the synapses connecting the neurons in the image 110 based on the proximity of the neurons. For example, the graphing system may determine that a first neuron is connected by a synapse to a second neuron based on the area of overlap between: (i) a tolerance region in the image around the first neuron, and (ii) a tolerance region in the image around the second neuron. That is, the graphing system may determine whether the first neuron and the second neuron are connected based on the number of spatial locations (e.g., voxels) that are included in both: (i) the tolerance region around the first neuron, and (ii) the tolerance region around the second neuron. For example, the graphing system may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system may further identify a weight value associated with each edge in the graph 102. For example, the graphing system may identify a weight for an edge connecting two nodes in the graph 102 based on the area of overlap between the tolerance regions around the respective neurons corresponding to the nodes in the image 110. The area of overlap may be measured, e.g., as the number of voxels in the image 110 that are contained in the overlap of the respective tolerance regions around the neurons. The weight for an edge connecting two nodes in the graph 102 may be understood as characterizing the (approximate) strength of the connection between the corresponding neurons in the brain (e.g., the amount of information flow through the synapse connecting the two neurons).

In addition to identifying synapses in the image 110, the graphing system may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system determines the directions of the synapses in the image 110, the graphing system may associate each edge in the graph 102 with direction of the corresponding synapse. That is, the graph 102 may be a directed graph. In other implementations, the graph 102 may be an undirected graph, i.e., where the edges in the graph are not associated with a direction.

The graph 102 may be represented in any of a variety of ways. For example, the graph 102 may be represented as a two-dimensional array of numerical values, referred to as an “adjacency matrix”, with a number of rows and columns equal to the number of nodes in the graph. The component of the array at position (i,j) may have value 1 if the graph includes an edge pointing from node i to node j, and value 0 otherwise. In implementations where the graphing system determines a weight value for each edge in the graph 102, the weight values may be similarly represented as a two-dimensional array of numerical values. More specifically, if the graph includes an edge connecting node i to node j, the component of the array at position (i,j) may have a value given by the corresponding edge weight, and otherwise the component of the array at position (i,j) may have value 0.

The architecture selection system 400 processes the synaptic connectivity graph 102 to generate a brain emulation neural network 108. The architecture selection system may determine the neural network architecture of the brain emulation neural network by searching a space of possible neural network architectures. The architecture selection system 400 may seed (i.e., initialize) the search through the space of possible neural network architectures using the synaptic connectivity graph 102 representing synaptic connectivity in the brain 104 of the biological organism 106. An example architecture selection system 400 is described in more detail with reference to FIG. 4.

The image processing system 200 uses the brain emulation neural network 108 to process images to generate predictions, as will be described in more detail next.

FIG. 1B shows an example operating environment for the image processing system 200. A drone 120 can include an onboard camera 122 to capture images of an environment surrounding the drone 120, e.g., to capture potential landing spaces, hazards, etc. for the drone 120. The drone 120 can include an onboard control unit 124 including one or more computers implementing one or more computer programs including the image processing system 200. In some implementations, the control unit 124 can include wireless network connectivity, e.g., via satellite communication, Wi-Fi, etc., in data communication with a network.

FIG. 2 shows an example image processing system 200. The image processing system 200 is an example of a system implemented as computer programs on one or more computers in one or more locations in which the systems, components, and techniques described below are implemented. Image processing system 200 can be implemented as computer programs on one or more computers located onboard a drone, on one or more cloud-based servers (i.e., such that the drone provides imaging data to the system 200 in real-time to the cloud-based servers via a network for processing and receives back results of the processing), or a combination thereof. In one example, image processing system 200 is implemented as computer programs on one or more single-board computers, e.g., one or more Raspberry Pi boards or the like, located on the drone.

The system 200 is configured to process an image 202 using a drone image processing neural network 204 to generate a prediction 206 characterizing the image 202.

The image 202 may be captured by an onboard camera of a drone using any of a variety of imaging modalities. For example, the image 202 may be a visible light image, an infrared image, or a hyperspectral image. The image 202 may be represented, e.g., as an array of numerical values.

In some implementations, the system 200 can be configured to process point cloud data generated by one or more light detecting and ranging (LiDAR) sensors and/or one or more radio detecting and ranging (RADAR) sensors located on the drone. Processing by the system 200 of the point cloud data can proceed similarly as described with reference to the processing of image 202.

The drone image processing neural network 204 includes: (i) an input sub-network 208, (ii) a brain emulation sub-network 210, and (iii) an output sub-network 212, each of which will be described in more detail next. Throughout this specification, a “sub-network” refers to a neural network that is included as part of another, larger neural network.

In some implementations, the system 200 includes an image processing engine 201 to perform pre-processing of the image 202 prior to processing by the drone image processing neural network 204.

Image processing engine 201 can receive the image 202 as input and perform multiple operations on the image 202 to generate a modified image as output to the drone image processing neural network 204. In some implementations, operations performed on the image 202 by the image processing engine 201 include i) an edge enhancement operation and ii) a shape identification and orientation operation.

The edge enhancement operation can be performed on the image 202 to enhance the appearance of edges and lines within the image 202, e.g., to enhance the appearance of power lines, roads, etc., within the image 202. The edge enhancement operation can be performed utilizing a Laplacian of Gaussian (LoG) filter. The LoG filter can be additionally utilized to reduce blurriness in the image 202. Alternatively or additionally, the edge enhancement operation can be performed utilizing one or more other image processing techniques, for example, Difference of Gaussian (DoG) or another type of spatial filter/edge detector, e.g., bilateral filters, histogram equalization, canny filters, Hough transform, or the like.

The shape identification and orientation operation can be performed on the image 202 to identify particular shapes, e.g., lines, curves, or other canonical shapes, within the image 202 as well as an orientation of the identified particular shapes, e.g., an angular orientation of a line. The shape identification and orientation operation can be performed on the image 202 after the edge enhancement operation. The shape identification and orientation operation can be performed utilizing a Hough transform. In one example, the shape identification and orientation operation can be performed on the image to identify lines (e.g., power lines) and orientations of the lines (e.g., angular orientations of the power lines).

In some implementations, a shape identification and orientation operation can include a convolution with a “known” shape, i.e., convolving the image with a black and white image of a known shape, e.g., a box, triangle, or the like. A size of the “known” image can depend on a scale of the source imagery, in other words, if an object (e.g., a building) tends to be (on average) a given size, e.g., 10×10 pixels, then the source imagery that would be the size of the “known” image that is used to convolve with the source.

In some implementations, the image processing engine 201 performs a re-orientation operation on the image 202. The re-orientation operation can be applied to the image 202 after the edge enhancement operation and shape identification and orientation operation. The re-orientation operation can rotate the image 202 about an axis (e.g., a center point of the image) such that an identified shape (e.g., a line) having an identified orientation within the image 20 can be orientated along a predefined axis or at a predefined angular orientation relative to the particular axis. In one example, the re-orientation operation can be applied to the image 202 such that one or more lines appearing within the image are aligned vertically or horizontally relative to a global axis.

In some implementations, an axis can be defined based a distribution of orientations in a source data set (e.g., a distribution of orientations of power lines with respect to a border of the source imagery). The axis can be defined based on a most frequent orientation in the source data set such that the orientation can be defined as the “vertical” axis. For example, for a source data set, power lines may be most frequently oriented at 45 degrees with respect to a border of the source imagery such that 45 degrees is selected to be the global axis.

In some implementations, one or more of the functions described with reference to the image processing engine 201 can be (implicitly) performed by the input sub-network 208 of the drone image processing neural network 204.

The image output from the image processing engine 201 is provided as input to the input sub-network 208. The input sub-network 208 is configured to process the image 202 to generate an embedding of the image 202, i.e., a representation of the image 202 as an ordered collection of numerical values, e.g., a vector or matrix of numerical values. The input sub-network may have any appropriate neural network architecture that enables it to perform its described function, e.g., a neural network architecture that includes a single fully-connected neural network layer.

The brain emulation sub-network 210 is configured to process the embedding of the image 202 (i.e., that is generated by the input sub-network) to generate an alternative representation of the image, e.g., as an ordered collection of numerical values, e.g., a vector, matrix, or tensor of numerical values. The architecture of the brain emulation sub-network 210 is derived from a synaptic connectivity graph representing synaptic connectivity in the brain of a biological organism. The brain emulation sub-network 210 may be generated, e.g., by an architecture selection system, which will be described in more detail with reference to FIG. 4.

The output sub-network 212 is configured to process the alternative representation of the image (i.e., that is generated by the brain emulation sub-network 210) to generate the prediction 206 characterizing the image 202. The output sub-network 212 may have any appropriate neural network architecture that enables it to perform its described function, e.g., a neural network architecture that includes a single fully-connected layer.

In some cases, the brain emulation sub-network 210 may have a recurrent neural network architecture, i.e., where the connections in the architecture define one or more “loops.” More specifically, the architecture may include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output the second neuron, and the second neuron provides its output to the first neuron) would form a recurrent loop.

A recurrent brain emulation sub-network may process an image embedding (i.e., generated by the input sub-network) over multiple (internal) time steps to generate a respective alternative representation of the image at each time step. In particular, at each time step, the brain emulation sub-network may process: (i) the image embedding, and (ii) any outputs generated by the brain emulation sub-network at the preceding time step, to generate the alternative representation of the image for the time step. The drone image processing neural network 204 may provide the alternative representation of the image generated by the brain emulation sub-network at the final time step as the input to the output sub-network 212. The number of time steps over which the brain emulation sub-network 210 processes the image embedding may be a predetermined hyper-parameter of the image processing system 200.

In addition to processing the alternative representation of the image 202 generated by the output layer of the brain emulation sub-network 210, the output sub-network 212 may additionally process one or more intermediate outputs of the brain emulation sub-network 210. An intermediate output refers to an output generated by a hidden artificial neuron of the brain emulation sub-network, i.e., an artificial neuron that is not included in the input layer or the output layer of the brain emulation sub-network.

The drone image processing neural network 204 may be configured to generate any of a variety of predictions 206 corresponding to the image 202. A few examples of predictions 206 that may be generated by the drone image processing neural network 204 are described in more detail next.

In one example, the drone image processing neural network 204 may be configured to generate a prediction 206 that defines a segmentation of the image 202 into multiple possible categories. The segmentation of the image 202 may include, for each pixel of the image 202, a respective score for each possible category that defines a likelihood that the pixel is included in the possible category. The set of possible categories may include one or more of: a “power line” category, a “roadway” category, a “vegetation” or “tree” category, a “building” category, and a “default” category (e.g., such that each pixel that is not included in any other category may be understood as being included in the default category). The categories may each designate a type of hazard that the drone can encounter while navigating in flight and that can constitute a potential unsafe or safe zone for landing for the drone.

In another example, the drone image processing neural network 204 may be configured to generate a prediction 206 that defines a classification of the image 202 into multiple possible classes. The classification of the image may include a respective score for each possible class that defines a likelihood that the image is included in the class. In one example, the possible classes may include: (i) a first class indicating that at least a threshold area of the image is occupied by a certain category of entity, and (ii) a second class indicating that less than a threshold area of the image is occupied by the category of entity. The category of entity may be, e.g., power lines, roadways, vegetation, building, etc. The threshold area of the image may be, e.g., 10%, 20%, 30%, or any other appropriate threshold area.

In another example, the drone image processing neural network 204 may be configured to generate a prediction 206 that is drawn from a continuous range of possible values, i.e., the drone image processing neural network 204 may perform a regression task. For example, the prediction 206 may define a fraction of the area of the image that is occupied by a certain category of entity, e.g., power line, roadway, vegetation (tree), or building. In this example, the continuous range of possible output values may be, e.g., the range [0,1].

In another example, the drone image processing neural network 204 may be configured to generate a binary prediction 206, e.g., 0/1 binary prediction, representative of a safe/not-safe to land determination at a particular location. In other words, the drone image processing neural network 204 processes the image 200 to generate either a “0” or “1” value output (or a value in the continuous range [0,1]), representative of either a “safe” or “not-safe” landing prediction.

In another example, the drone image processing neural network 204 may be configured to generate a detection prediction 206. In other words, the drone image processing neural network 204 processes the image 200 to generate a level of confidence (e.g., between 0 and 1) whether there is a power line (or another hazard) in the image.

The predictions 206 generated by the drone image processing neural network 204 can be used for any of a variety of purposes. A few example use cases for the predictions 206 generated by the drone image processing neural network 204 are described in more detail next.

In one example, the drone image processing neural network 204 may be configured to generate hazard segmentations of images, i.e., that generates a confidence estimate between 0 and 1 of how likely each pixel of the image is included in a hazard, e.g., a power line, a tree, a roadway, or another potentially hazardous object to a drone. Based on these confidence estimates, the drone image processing neural network 204 may be configured to generate a prediction 206 that designates within each image 202 a “safe” landing zone and/or an “unsafe” landing zone.

In some implementations, the safe landing zone can include an area of a particular dimensions within the image that does not include pixels (or includes fewer than a threshold percentage of pixels) that are classified as occupied by entities that are categorized as hazards, e.g., power lines, roadways, vegetation, etc. In other words, at least a threshold area corresponding to respective pixels to accommodate the drone footprint that does not include a hazard. The unsafe landing zone can include an area within the image that includes pixels (or includes more than a threshold percentage of pixels) that are classified as occupied by entities that are categorized as hazards.

In some implementations, the safe landing zone can include an image that is not determined to include pixels that are classified as occupied by entities that are categorized as hazards. In other words, if any (or at least a threshold percentage) of the pixels of the image are classified as occupied by hazards, the image can be determined to be an unsafe landing zone. For example, if the image is determined to include pixels that are classified as occupied by a human, the area encompassed by the image is determined to be an unsafe landing zone.

In some implementations, predictions 206 output by the drone image processing neural network 204 can be provided to a navigation/planning system of the drone that can be utilized to generate control signals for operating the drone. For example, predictions 206 can be provided to a navigation system to generate control signals for course correction, e.g., by adjusting propeller speed/direction.

In another example, the drone image processing neural network 204 may be configured to generate segmentations of images into categories that include one or more static landmark categories, i.e., categories corresponding to stationary entities that do not move over time, e.g., roadways or buildings. In this example, the static landmark segmentations generated by the drone image processing neural network may be used to register (i.e., align) images. More specifically, to register two images captured by an onboard camera of a drone having overlapping fields of view (e.g., as the drone is moving in real-time), the drone image processing neural network may process each image to generate a respective static landmark segmentation of each image, e.g., a segmentation of the respective roadways depicted in each image. The respective static landmark segmentation of each image may be provided to an optimization system that determines the parameters of a transformation (e.g., an affine or elastic transformation) that (approximately or exactly) aligns the static landmark segmentations of the images captured by the onboard camera of the drone in real-time. For example, the optimization system may use a black-box optimization technique to determine the parameters of a transformation that maximizes the overlap of the static landmark segmentations. After determining the parameters of the transformation that aligns the static landmark segmentations of the images, the same transformation may be applied to the original images to (approximately or exactly) align the original images. The static landmark(s) identified by the drone image processing neural network 204 can be utilized by control software for the drone to navigate while the drone is in flight, e.g., to recognize a direction of motion of the drone relative to the static landmark(s).

The image processing system 200 may use a training engine 214 to train the drone image processing neural network 204, i.e., to enable the drone image processing neural network 204 to generate accurate predictions. The training engine 214 may train the drone image processing neural network 204 on a set of training data that includes multiple training examples, where each training example specifies: (i) an image, and (ii) a target prediction corresponding to the image. The target prediction corresponding to the image defines the prediction that should be generated by the drone image processing neural network 204 by processing the image.

At each of multiple training iterations, the training engine 214 may sample a batch (i.e., set) of training examples from the training data, and process the respective image included in each training example using the drone image processing neural network 204 to generate a corresponding prediction. The training engine 214 may determine gradients of an objective function with respect to the drone image processing neural network parameters, where the objective function measures an error between: (i) the predictions generated by the drone image processing neural network, and (ii) the target predictions specified by the training examples. The training engine 214 may use the gradients of the objective function to update the values of the drone image processing neural network parameters, e.g., to reduce the error measured by the objective function. The error may be, e.g., a cross-entropy error, a squared-error, or any other appropriate error. The training engine 214 may determine the gradients of the objective function with respect to the drone image processing neural network parameters, e.g., using backpropagation techniques or other, biologically compatible techniques such as Hebbian learning. The training engine 214 may use the gradients to update the drone image processing neural network parameters using the update rule of a gradient descent optimization algorithm, e.g., Adam or RMSprop.

During training of the drone image processing neural network 204, the parameter values of the input sub-network 208 and the output sub-network 212 are trained, but some or all of the parameter values of the brain emulation sub-network 210 may be static, i.e., not trained. Instead of being trained, the parameter values of the brain emulation sub-network 210 may be determined from the weight values of the edges of the synaptic connectivity graph, as will be described in more detail below with reference to FIG. 4. Generally, the brain emulation sub-network may have a large number of parameters and a highly recurrent architecture as a result of being derived from the synaptic connectivity of a biological brain. Therefore training the brain emulation sub-network may be computationally-intensive and prone to failure, e.g., as a result of the parameter values of the brain emulation sub-network oscillating or diverging rather than converging to fixed values. The drone image processing neural network 204 may harness the capacity of the brain emulation sub-network, e.g., to generate representations that are effective for processing images, without requiring the brain emulation sub-network to be trained.

The training engine 214 may use any of a variety of regularization techniques during training of the drone image processing neural network 204. For example, the training engine 214 may use a dropout regularization technique, such that certain artificial neurons of the brain emulation sub-network are “dropped out” (e.g., by having their output set to zero) with a non-zero probability p>0 each time the brain emulation sub-network processes an input. Using the dropout regularization technique may improve the performance of the trained drone image processing neural network 204, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 214 may regularize the training of the drone image processing neural network 204 by including a “penalty” term in the objective function that measures the magnitude of the parameter values of the input sub-network 208, the output sub-network 212, or both. The penalty term may be, e.g., an L₁ or L₂ norm of the parameter values of the input sub-network 208, the output sub-network 212, or both.

In some cases, the values of the intermediate outputs of the brain emulation sub-network 210 may have large magnitudes, e.g., as a result of the parameter values of the brain emulation sub-network 210 being derived from the weight values of the edges of the synaptic connectivity graph rather than being trained. Therefore, to facilitate training of the drone image processing neural network 204, batch normalization layers may be included between the layers of the brain emulation sub-network 210, which can contribute to limiting the magnitudes of intermediate outputs generated by the brain emulation sub-network. Alternatively or in combination, the activation functions of the neurons of the brain emulation sub-network may be selected to have a limited range. For example, the activation functions of the neurons of the brain emulation sub-network may be selected to be sigmoid activation functions with range given by [0,1].

The example architecture of the drone image processing neural network (reservoir computing neural network) that is described with reference to FIG. 2 is provided for illustrative purposes only, and other architectures of the drone image processing neural network are possible. For example, the drone image processing neural network may include a sequence of multiple different brain emulation sub-networks, e.g., each generated by the architecture selection system described with reference to FIG. 4. In this example, the brain emulation sub-networks may be interleaved with sub-networks having parameter values that are trained during the training of the drone image processing neural network, i.e., in contrast to the parameter values of the brain emulation sub-networks. Generally, a drone image processing neural network 204 includes: (i) one or more brain emulation sub-networks having parameter values derived from a synaptic connectivity graph, and (ii) one or more trainable sub-networks. The brain emulation sub-networks and the trainable sub-networks may be connected in any of a variety of configurations.

In some implementations, multiple different brain emulation sub-networks 210 can each be selected to be sensitive to lines that are orientated at a particular spatial frequency, at a particular level of noise, and/or at a particular orientation, where the architecture selection system 400 can perform the selection of a brain emulation sub-network 210 that enables most effective auto-encoding of images 200 with line oriented in the particular angular orientation. For example, the multiple brain emulation sub-networks 210 can include 64 different emulations which are each sensitive to a different angular orientation of 64 angular orientations of a line within an image 202. In another example, the multiple brain emulation sub-networks 210 can include 2 different brain emulation neural networks which are each sensitive to a respective horizontal orientation and vertical orientation of a line within an image 202.

In some implementations, brain emulation sub-networks 210 can be selected to be sensitive to lines in particular orientations, e.g., horizontal or vertical orientations, and including an angular tolerance with respect to the particular orientation. For example, a brain emulation sub-network can be selected to be sensitive to lines that are between −1 and +1 degrees of a horizontal orientation. In another example, a brain emulation sub-network can be selected to be sensitive to lines that are oriented between 89 and 91 degrees of vertical.

The multiple brain emulation sub-networks 210 can be included in a respective drone image processing neural network. Each received image 200 captured by the onboard drone is provided to a particular drone image processing neural network including a brain emulation sub-network 210 that is determined to be most effective for processing the particular received image 200. For example, a particular drone image processing neural network of multiple drone image processing neural networks can be selected based on the brain emulation sub-network of the particular drone image processing neural network being determined to be most effective for processing a received image including horizontal power lines (e.g., to perform an auto-encoding task).

In some implementations, multiple brain emulation sub-networks 210 can be selected by architecture selection system 400 to be sensitive to respective imaging distances, e.g., 0-50 feet, 50-100 feet, etc. In other words, multiple drone image processing neural networks each include a respective brain emulation sub-network determined to be most effective for processing a received image captured by an onboard camera of a drone at a particular height above ground.

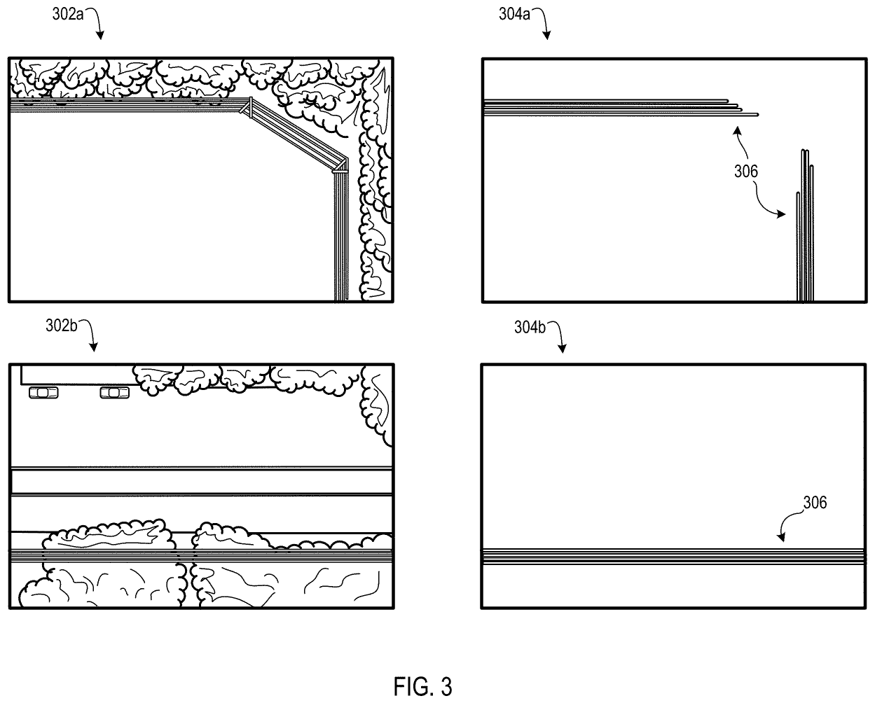

FIG. 3 shows an example of images 302a and 302b captured by an onboard camera of a drone, and examples of respective hazard segmentations 304a and 304b of the images 302a and 302b that may be generated by the drone image processing neural network described with reference to FIG. 2. The drone image processing neural network may generate a hazard segmentation that defines, for each pixel in an image, a score that indicates a likelihood that the pixel is included in a hazard, e.g., a power line. As depicted in FIG. 3, a hazard segmentation of the images 302a and 302b can distinguish the pixels 306 that the drone image processing neural network has determined are likely to include power lines from background of the image (e.g., by depicting the identified hazard pixels in white and all other pixels as black).

FIG. 4 shows an example architecture selection system 400. The architecture selection system 400 is an example of a system implemented as computer programs on one or more computers in one or more locations in which the systems, components, and techniques described below are implemented.

The system 400 is configured to search a space of possible neural network architectures to identify the neural network architecture of a brain emulation neural network 108 to be included in a drone image processing neural network that processes images, e.g., as described with reference to FIG. 2. The system 400 seeds the search through the space of possible neural network architectures using a synaptic connectivity graph 102 representing synaptic connectivity in the brain of a biological organism. The synaptic connectivity graph 102 may be derived directly from a synaptic resolution image of the brain of a biological organism, e.g., as described with reference to FIG. 1A. In some cases, the synaptic connectivity graph 102 may be a sub-graph of a larger graph derived from a synaptic resolution image of a brain, e.g., a sub-graph that includes neurons of a particular type, e.g., visual neurons, association neurons.

The system 400 includes a graph generation engine 402, an architecture mapping engine 404, a training engine 406, and a selection engine 408, each of which will be described in more detail next.

The graph generation engine 402 is configured to process the synaptic connectivity graph 102 to generate multiple “brain emulation” graphs 410, where each brain emulation graph is defined by a set of nodes and a set of edges, such that each edge connects a pair of nodes. The graph generation engine 402 may generate the brain emulation graphs 410 from the synaptic connectivity graph 102 using any of a variety of techniques. A few examples follow.

In one example, the graph generation engine 402 may generate a brain emulation graph 410 at each of multiple iterations by processing the synaptic connectivity graph 102 in accordance with current values of a set of graph generation parameters. The current values of the graph generation parameters may specify (transformation) operations to be applied to an adjacency matrix representing the synaptic connectivity graph 102 to generate an adjacency matrix representing a brain emulation graph 410. The operations to be applied to the adjacency matrix representing the synaptic connectivity graph may include, e.g., filtering operations, cropping operations, or both. The brain emulation graph 410 may be defined by the result of applying the operations specified by the current values of the graph generation parameters to the adjacency matrix representing the synaptic connectivity graph 102.

The graph generation engine 402 may apply a filtering operation to the adjacency matrix representing the synaptic connectivity graph 102, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 102 may have the effect of adding edges to the synaptic connectivity graph 102, removing edges from the synaptic connectivity graph 102, or both.

The graph generation engine 402 may apply a cropping operation to the adjacency matrix representing the synaptic connectivity graph 102, where the cropping operation replaces the adjacency matrix representing the synaptic connectivity graph 102 with an adjacency matrix representing a sub-graph of the synaptic connectivity graph 102. The cropping operation may specify a sub-graph of synaptic connectivity graph 102, e.g., by specifying a proper subset of the rows and a proper subset of the columns of the adjacency matrix representing the synaptic connectivity graph 102 that define a sub-matrix of the adjacency matrix. The sub-graph may include: (i) each edge specified by the sub-matrix, and (ii) each node that is connected by an edge specified by the sub-matrix.

At each iteration, the system 400 determines a performance measure 412 corresponding to the brain emulation graph 410 generated at the iteration, and the system 400 updates the current values of the graph generation parameters to encourage the generation of brain emulation graphs 410 with higher performance measures 412. The performance measure 412 for a brain emulation graph 410 characterizes the performance of a drone image processing neural network that includes a brain emulation neural network having an architecture specified by the brain emulation graph 410 at processing images to perform a task. Determining performance measures 412 for brain emulation graphs 410 will be described in more detail below. The system 400 may use any appropriate optimization technique to update the current values of the graph generation parameters, e.g., a “black-box” optimization technique that does not rely on computing gradients of the operations performed by the graph generation engine 402. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 402 may generate the brain emulation graphs 410 by “evolving” a population (i.e., a set) of graphs derived from the synaptic connectivity graph 102 over multiple iterations. The graph generation engine 402 may initialize the population of graphs, e.g., by “mutating” multiple copies of the synaptic connectivity graph 102. Mutating a graph refers to making a random change to the graph, e.g., by randomly adding or removing edges or nodes from the graph. After initializing the population of graphs, the graph generation engine 402 may generate a brain emulation graph at each of multiple iterations by, at each iteration, selecting a graph from the population of graphs derived from the synaptic connectivity graph and mutating the selected graph to generate a brain emulation graph 410. The graph generation engine 402 may determine a performance measure 412 for the brain emulation graph 410, and use the performance measure to determine whether the brain emulation graph 410 is added to the current population of graphs.

In some implementations, each edge of the synaptic connectivity graph may be associated with a weight value that is determined from the synaptic resolution image of the brain, as described above. Each brain emulation graph may inherit the weight values associated with the edges of the synaptic connectivity graph. For example, each edge in the brain emulation graph that corresponds to an edge in the synaptic connectivity graph may be associated with the same weight value as the corresponding edge in the synaptic connectivity graph. Edges in the brain emulation graph that do not correspond to edges in the synaptic connectivity graph may be associated with default or randomly initialized weight values.

In another example, the graph generation engine 402 can generate each brain emulation graph 410 as a sub-graph of the synaptic connectivity graph 102. For example, the graph generation engine 402 can randomly select sub-graphs, e.g., by randomly selecting a proper subset of the rows and a proper subset of the columns of the adjacency matrix representing the synaptic connectivity graph that define a sub-matrix of the adjacency matrix. The sub-graph may include: (i) each edge specified by the sub-matrix, and (ii) each node that is connected by an edge specified by the sub-matrix.

The architecture mapping engine 404 processes each brain emulation graph 410 to generate a corresponding brain emulation neural network architecture 414. The architecture mapping engine 404 may use the brain emulation graph 410 derived from the synaptic connectivity graph 102 to specify the brain emulation neural network architecture 414 in any of a variety of ways. For example, the architecture mapping engine may map each node in the brain emulation graph 410 to a corresponding: (i) artificial neuron, (ii) artificial neural network layer, or (iii) group of artificial neural network layers in the brain emulation neural network architecture, as will be described in more detail next.

In one example, the brain emulation neural network architecture may include: (i) a respective artificial neuron corresponding to each node in the brain emulation graph 410, and (ii) a respective connection corresponding to each edge in the brain emulation graph 410. In this example, the brain emulation graph may be a directed graph, and an edge that points from a first node to a second node in the brain emulation graph may specify a connection pointing from a corresponding first artificial neuron to a corresponding second artificial neuron in the brain emulation neural network architecture. The connection pointing from the first artificial neuron to the second artificial neuron may indicate that the output of the first artificial neuron should be provided as an input to the second artificial neuron. Each connection in the brain emulation neural network architecture may be associated with a weight value, e.g., that is specified by the weight value associated with the corresponding edge in the brain emulation graph. An artificial neuron may refer to a component of the brain emulation neural network architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the brain emulation graph 410 may be an undirected graph, and the architecture mapping engine 404 may map an edge that connects a first node to a second node in the brain emulation graph 410 to two connections between a corresponding first artificial neuron and a corresponding second artificial neuron in the brain emulation neural network architecture. In particular, the architecture mapping engine 404 may map the edge to: (i) a first connection pointing from the first artificial neuron to the second artificial neuron, and (ii) a second connection pointing from the second artificial neuron to the first artificial neuron.

In another example, the brain emulation graph 410 may be an undirected graph, and the architecture mapping engine may map an edge that connects a first node to a second node in the brain emulation graph 410 to one connection between a corresponding first artificial neuron and a corresponding second artificial neuron in the brain emulation neural network architecture. The architecture mapping engine may determine the direction of the connection between the first artificial neuron and the second artificial neuron, e.g., by randomly sampling the direction in accordance with a probability distribution over the set of two possible directions.

In another example, the brain emulation neural network architecture may include: (i) a respective artificial neural network layer corresponding to each node in the brain emulation graph 410, and (ii) a respective connection corresponding to each edge in the brain emulation graph 410. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the brain emulation neural network architecture may include a respective convolutional neural network layer corresponding to each node in the brain emulation graph 410, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each connection may be specified by the weight value associated with the corresponding edge in the brain emulation graph), h_{θ}(⋅) represents the operation of applying one or more convolutional kernels to an input to generate a corresponding output, and σ(⋅) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture mapping engine may determine that the brain emulation neural network architecture includes: (i) a respective group of artificial neural network layers corresponding to each node in the brain emulation graph 410, and (ii) a respective connection corresponding to each edge in the brain emulation graph 410. The layers in a group of artificial neural network layers corresponding to a node in the brain emulation graph 410 may be connected, e.g., as a linear sequence of layers, or in any other appropriate manner.

The brain emulation neural network architecture 414 may include one or more artificial neurons that are identified as “input” artificial neurons and one or more artificial neurons that are identified as “output” artificial neurons. An input artificial neuron may refer to an artificial neuron that is configured to receive an input from a source that is external to the brain emulation neural network. An output artificial neural neuron may refer to an artificial neuron that generates an output which is considered part of the overall output generated by the brain emulation neural network. The architecture mapping engine may add artificial neurons to the brain emulation neural network architecture in addition to those specified by nodes in the synaptic connectivity graph, and designate the added neurons as input artificial neurons and output artificial neurons. For example, for a brain emulation neural network that is configured to process an input including a 100×100 matrix to generate an output that includes a 1000-dimensional vector, the architecture mapping engine may add 10,000 (=100×100) input artificial neurons and 1000 output artificial neurons to the architecture. Input and output artificial neurons that are added to the brain emulation neural network architecture may be connected to the other neurons in the brain emulation neural n network architecture in any of a variety of ways. For example, the input and output artificial neurons may be densely connected to every other neuron in the brain emulation neural network architecture.

For each brain emulation neural network architecture 414, the training engine 406 instantiates a drone image processing neural network 416 that includes a brain emulation sub-network having the brain emulation neural network architecture 414. Examples of drone image processing neural networks that include brain emulation sub-networks are described in more detail with reference to FIG. 2. Each drone image processing neural network 416 is configured to perform an image processing task, e.g., a prediction task or an auto-encoding task. In a prediction task, the drone image processing neural network is configured to process an image to generate a prediction characterizing the image, e.g., a segmentation, classification, or regression prediction, as described above. In an auto-encoding task, the drone image processing neural network is configured to process an image to generate a “reconstruction” (i.e., estimate) of the image.

The training engine 406 is configured to train each drone image processing neural network 416 to perform an image processing task over multiple training iterations. Training a drone image processing neural network that includes a brain emulation sub-network to perform a prediction task is described with reference to FIG. 2. Training a drone image processing neural network to perform an auto-encoding task proceeds similarly, except that the objective function being optimized measures an error between: (i) an image, and (ii) a reconstruction of the image that is generated by the drone image processing neural network.

The training engine 406 determines a respective performance measure 412 of each drone image processing neural network 416 on the image processing task. For example, to determine the performance measure, the training engine 406 may obtain a “validation” set of images that were not used during training of the drone image processing neural network, and process each of these images using the trained drone image processing neural network to generate a corresponding output. The training engine 406 may then determine the performance measure 412 based on the respective error between: (i) the output generated by the drone image processing neural network for the image, and (ii) a target output for the image, for each image in the validation set. For a prediction task, the target output for an image may be, e.g., a ground-truth segmentation, classification, or regression output. For an auto-encoding task, the target output for an image may be the image itself. The training engine 406 may determine the performance measure 412, e.g., as the average error or the maximum error over the images in the validation set.

The selection engine 408 uses the performance measures 412 to generate the output brain emulation neural network 108. In one example, the selection engine 408 may generate a brain emulation neural network 108 having the brain emulation neural network architecture 414 associated with the best (e.g., highest) performance measure 412.

If the performance measures 412 characterize the performance of the drone image processing neural networks 416 on a prediction task, then the architecture selection system 400 may generate a brain emulation neural network 108 that is tuned for effective performance on the specific prediction task. If, on the other hand, the performance measures 412 characterize the performance of the drone image processing neural networks 416 on an auto-encoding task, then the architecture selection system 400 may generate a brain emulation neural network 108 that is generally effective for a variety of prediction tasks that involve processing images.

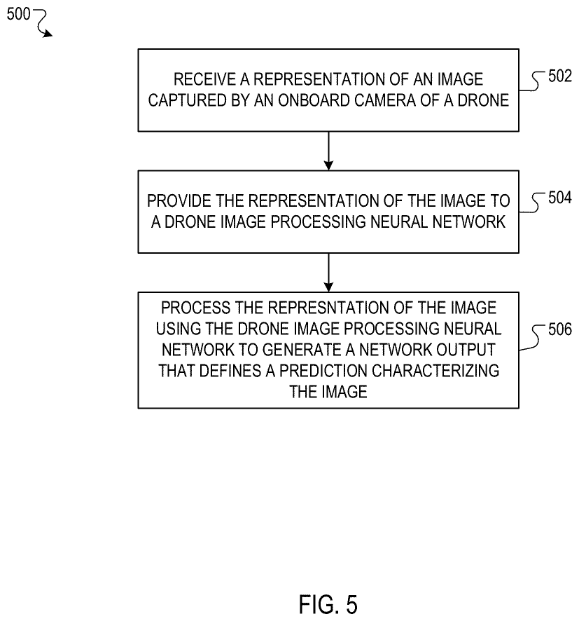

FIG. 5 is a flow diagram of an example process 500 for processing an image using a drone image processing neural network to generate a prediction characterizing the image. For convenience, the process 500 will be described as being performed by a system of one or more computers located in one or more locations. For example, an image processing system, e.g., the image processing system 200 of FIG. 2, appropriately programmed in accordance with this specification, can perform the process 500.

The system receives representation of an image captured by an onboard camera of a drone (502). In some implementations, the system receives images captured by an onboard camera of a drone in real-time and at particular capture rate, e.g., 1 Hz, faster than 1 Hz, etc. Each image is processed by the system at a rate faster than the capture rate of the onboard camera, such that system generates prediction for each image before the next image is captured. Predictions generated by the system can be utilized by drone control software to assess in real-time a safe location to land the drone based on the captured images.

The system provides the representation of the image to a drone image processing neural network (504). In some implementations, as described with reference to FIG. 2, the system performs pre-processing on the image including i) an edge enhancement operation and ii) a shape identification and orientation operation, e.g., a Laplacian of Gaussian filter and a Hough transform. The pre-processed image can be rotated to align an orientation of a shape within the image along a particular axis or at a particular angular orientation relative to a particular axis, e.g., align a line along a horizontal or vertical axis.

In some implementations, the system provides the representation of the image to an input sub-network to generate an embedding of the image.

The system processes the representation of the image using the drone image processing neural network to generate a network output that defines a prediction characterizing the image (506). The values of at least some of the brain emulation sub-network parameters may be determined before the drone image processing neural network is trained and not be adjusted during training of the drone image processing neural network. The brain emulation sub-network has a neural network architecture that is specified by a brain emulation graph, where the brain emulation graph is generated based on a synaptic connectivity graph representing synaptic connectivity between neurons in a brain of a biological organism. The synaptic connectivity graph specifies a set of nodes and a set of edges, where each edge connects a pair of nodes, each node corresponds to a respective neuron in the brain of the biological organism. Each edge connecting a pair of nodes in the synaptic connectivity graph may correspond to a synaptic connection between a pair of neurons in the brain of the biological organism.

In some implementations, the system processes the alternative representation of the image using an output sub-network of the drone image processing neural network to generate a prediction characterizing the image. The prediction may be, e.g., a hazard segmentation of the image that defines, for each pixel of the image, a respective likelihood that the pixel is included in a hazard depicted in the image.

In some implementations, the system can perform image processing and hazard identification using a same drone image processing neural network (e.g., including a same brain emulation sub-network based on a synaptic connectivity graph) for images captured by an onboard drone at different resolutions (e.g., captured by the drone at different altitudes).

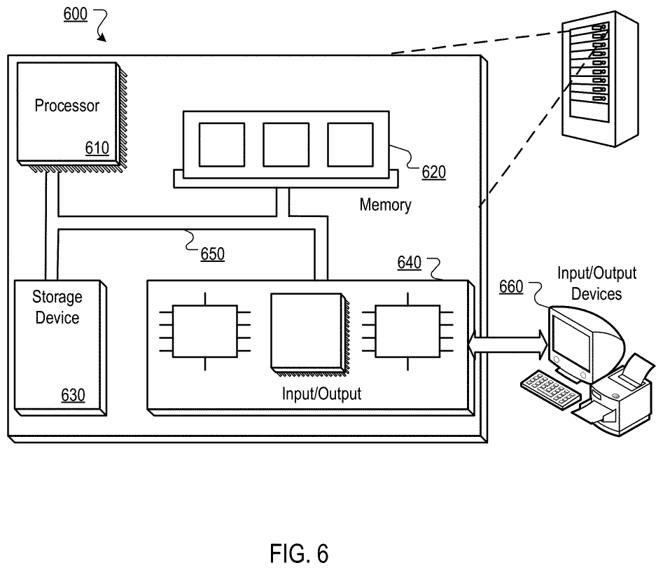

FIG. 6 is a block diagram of an example computer system 600 that can be used to perform operations described previously. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 802.11 card. In another implementation, the input/output device 640 can include driver devices configured to receive input data and send output data to other input/output devices, for example, keyboard, printer and display devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
receiving a representation of an image captured by an onboard camera of a drone;
providing the representation of the image to a drone image processing neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the representation of the image using the drone image processing neural network having the brain emulation sub-network to generate a network output that defines a prediction characterizing the image captured by the onboard camera of the drone.

2. The method of claim 1, wherein the prediction characterizing the image comprises a segmentation of the image into a plurality of possible categories.

3. The method of claim 2, wherein the segmentation of the image into the plurality of possible categories comprises, for each pixel of the image, a respective score for each of the plurality of possible categories, wherein the score for a possible category defines a likelihood that the pixel is included in the possible category.

4. The method of claim 3, wherein the plurality of possible categories includes one or more of i) a power line category, ii) a road category, or iii) a vegetation category,
wherein a pixel is included in the power line category if the pixel is included in a power line depicted in the image,
wherein the pixel is included in the road category if the pixel is included in a road depicted in the image, and
wherein the pixel is included in the vegetation category if the pixel is included in vegetation depicted in the image.

5. The method of claim 1, wherein the prediction characterizing the image comprises a classification of the image into a plurality of possible classes.

6. The method of claim 5, wherein the classification of the image into the plurality of possible classes includes a respective score for each possible class, wherein the score for a possible class defines a likelihood that the image is included in the possible class.

7. The method of claim 6, wherein the plurality of possible classes include: (i) a first class indicating that less than a threshold area of the image is occupied by a category of entity, and (ii) a second class indicating that at least the threshold area of the image is occupied by the category of entity; and
wherein the category of entity comprises a hazard that is i) a power line, ii) vegetation, or iii) a road.

8. The method of claim 1, wherein the drone image processing neural network further comprises an input sub-network, wherein the input sub-network is configured to process the image to generate an embedding of the image, wherein the brain emulation sub-network is configured to process the embedding of the image that is generated by the input sub-network.

9. The method of claim 1, further comprising applying one or more predefined image processing operations to the image prior to providing the representation of the image to the drone image processing neural network.

10. The method of claim 9, wherein the image processing comprises an edge enhancement operation including applying a Laplacian of Gaussian filter to the image.

11. The method of claim 10, wherein the image processing comprises identification of one or more lines depicted in the image and a respective orientation of each of the one or more lines.

12. The method of claim 11, wherein the image processing further comprises reorienting the image to align at least one line captured within the image along a predefined axis.

13. The method of claim 1, wherein the drone image processing neural network further comprises an output sub-network, wherein the output sub-network is configured to process the network output generated by the brain emulation sub-network to generate the prediction characterizing the image.

14. The method of claim 1, wherein processing the representation of the image using the drone image processing neural network having the brain emulation sub-network is performed by an onboard computer system of the drone.

15. The method of claim 1, further comprising providing the prediction characterizing the image to a navigation system of the drone, wherein the navigation system of the drone generates control signals for operation of the drone.

16. The method of claim 1, wherein specifying the brain emulation sub-network architecture further comprises, for each pair of artificial neurons in the brain emulation sub-network that are connected by a respective connection:
instantiating a weight value for the connection based on a proximity of a pair of biological neurons in the brain of the biological organism that correspond to the pair of artificial neurons in the brain emulation sub-network.

17. The method of claim 16, wherein weight values associated with respective particular synaptic connections between pairs of neurons in the brain is based on the proximity of the pair of neurons in the brain of the biological organism.

18. The method of claim 17, wherein the values of the brain emulation sub-network parameters are static during training of the brain-emulation sub-network.

19. A system comprising:
one or more computers; and
one or more storage devices communicatively coupled to the one or more computers, wherein the one or more storage devices store instructions that, when executed by the one or more computers, cause the one or more computers to perform operations comprising:
receiving a representation of an image captured by an onboard camera of a drone;
providing the representation of the image to a drone image processing neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the representation of the image using the drone image processing neural network having the brain emulation sub-network to generate a network output that defines a prediction characterizing the image captured by the onboard camera of the drone.

20. One or more non-transitory computer storage media storing instructions that when executed by one or more computers cause the one or more computers to perform operations comprising:
receiving a representation of an image captured by an onboard camera of a drone;
providing the representation of the image to a drone image processing neural network having a brain emulation sub-network with an architecture that is specified by synaptic connectivity between neurons in a brain of a biological organism, wherein specifying the brain emulation sub-network architecture comprises:
instantiating a respective artificial neuron in the brain emulation sub-network corresponding to each biological neuron of a plurality of biological neurons in the brain of the biological organism; and
instantiating a respective connection between each pair of artificial neurons in the brain emulation sub-network that correspond to a pair of biological neurons in the brain of the biological organism that are connected by a synaptic connection; and
processing the representation of the image using the drone image processing neural network having the brain emulation sub-network to generate a network output that defines a prediction characterizing the image captured by the onboard camera of the drone.
